(19) United States
(12) Patent Application Publication
(10) Pub. No.: US 2026/0057252 A1
(43) Pub. Date: Feb. 26, 2026

(54) TASK VARIABLE CAUSAL GRAPH CONSTRUCTION METHOD AND APPARATUS, DEVICE AND MEDIUM

(71) Applicant: Hangzhou Dianzi University, Hangzhou City (CN)

(72) Inventors: Yihao SHI, Hangzhou City (CN); Yuxia CHENG, Hangzhou City (CN); Gangyong JIA, Hangzhou City (CN); Qing WU, Hangzhou City (CN)

(21) Appl. No.: 18/941,640

(22) Filed: Nov. 8, 2024

(30) Foreign Application Priority Data
Aug. 20, 2024 (CN) 202411146591.3

(51) Int. Cl. G06N 5/01; G06N 5/02

(52) U.S. Cl. CPC G06N 5/01; G06N 5/02

(57) ABSTRACT

The present application provides a task variable causal graph construction method and apparatus, a device, and a medium. The method includes: obtaining a variable set and application task information corresponding to a target application task; determining priori knowledge by using a large language model based on the variable set and the application task information corresponding to the target application task; and determining a best causal graph by using a Monte Carlo tree search method based on the priori knowledge and data independence tests, where nodes in the best causal graph correspond one-to-one to the variables in the variable set, each edge in the best causal graph represents a causal relationship between variables corresponding to two nodes connected by the edge, and the best causal graph is used for root cause analysis of a downstream task. The present application improves the accuracy of causal graphs and the effectiveness of downstream tasks.

### CROSS REFERENCE TO RELATED APPLICATION

This patent application claims the benefit and priority of Chinese Patent Application No. 202411146591.3, filed with the China National Intellectual Property Administration on Aug. 20, 2024, the disclosure of which is incorporated by reference herein in its entirety as part of the present application.

### TECHNICAL FIELD

The present application relates to the field of causal discovery, and in particular, to a task variable causal graph construction method and apparatus, a device, and a medium.

### BACKGROUND

When establishing a causal graph between variables, existing causal discovery methods are primarily data-driven. These methods infer the causal relationship between variables from data through data analysis and mathematical modeling. Common methods include independence test-based methods and large language model-based methods. Independence test-based methods, such as the Peter-Clark (PC) algorithm, determine the causal relationship between variables by testing conditional independence between variables and then analyze the structure of the causal graph to determine the direction of causation. However, conditional independence test results do not always align with the true causal relationship between variables, and not all directions of causation can be accurately determined. On the other hand, large language model-based methods rely on knowledge of the large language model to determine the causal relationship between variables. The main limitation here is that the large language model uses only the knowledge input for training and does not incorporate data. Furthermore, the output from the large language model may be uncertain and may not always provide the correct answers.

Therefore, existing causal graph construction methods face two primary challenges: First, the accuracy of causal graphs obtained through knowledge or mathematical analysis alone is often insufficient. Second, the causal graphs produced may not be effective for downstream tasks, such as root cause analysis.

### SUMMARY

The purpose of the present application is to provide a task variable causal graph construction method and apparatus, a device, and a medium, which can improve the accuracy of causal graphs and the effectiveness of downstream tasks.

To achieve the above objective, the present application provides the following technical solutions.

According to a first aspect, the present application provides a task variable causal graph construction method, including:
obtaining a variable set and application task information corresponding to a target application task, where the variable set includes a plurality of variables, and the application task information includes background information and variable information of the target application task;
determining priori knowledge by using a large language model based on the variable set and the application task information corresponding to the target application task, where the priori knowledge includes a causal relationship between every two variables in the variable set; and
determining a best causal graph by using a Monte Carlo tree search method based on the priori knowledge and data independence tests, where nodes in the best causal graph correspond one-to-one to the variables in the variable set, each edge in the best causal graph represents a causal relationship between variables corresponding to two nodes connected by the edge, and the best causal graph is used for root cause analysis of a downstream task.

According to a second aspect, the present application provides a task variable causal graph construction apparatus, including:
an information obtaining module configured to obtain a variable set and application task information corresponding to a target application task, where the variable set includes a plurality of variables, and the application task information includes background information and variable information of the target application task;
a priori knowledge determining module configured to determine priori knowledge by using a large language model based on the variable set and the application task information corresponding to the target application task, where the priori knowledge includes a causal relationship between every two variables in the variable set; and
a best causal graph determining module configured to determine a best causal graph by using a Monte Carlo tree search method based on the priori knowledge and data independence tests, where nodes in the best causal graph correspond one-to-one to the variables in the variable set, each edge in the best causal graph represents a causal relationship between variables corresponding to two nodes connected by the edge, and the best causal graph is used for root cause analysis of a downstream task.

According to a third aspect, the present application provides a computer device, including a memory, a processor, and a computer program stored in the memory and executable on the processor, where the processor executes the computer program to implement the above task variable causal graph construction method.

According to a fourth aspect, the present application provides a computer-readable storage medium, storing a computer program thereon, where the computer program, when executed by a processor, implements the above task variable causal graph construction method.

According to specific examples provided in the present application, the present application discloses the following technical effects:

The present application provides a task variable causal graph construction method and apparatus, a device, and a medium. The causal graph is constructed through Monte Carlo tree searching, with pruning and optimization performed using the knowledge of the large language model based on the graph structure and data independence tests on variables. This approach speeds up the search process. Data analysis is used to feed back search results, enhancing the quality of the causal graph, which in turn improves the effectiveness of the downstream task. This method addresses the issue of existing causal discovery methods that rely heavily on data, which often results in low accuracy of causal graphs and poor performance of downstream tasks.

### BRIEF DESCRIPTION OF THE DRAWINGS

To describe the technical solutions in the examples of the present application or in the prior art more clearly, the following briefly describes the accompanying drawings required for the examples. Apparently, the accompanying drawings in the following description show merely some examples of the present application, and a person of ordinary skill in the art may still derive other accompanying drawings from these accompanying drawings without creative efforts.

FIG. 1 is a diagram of an application environment for a task variable causal graph construction method according to an embodiment of the present application;

FIG. 2 is a schematic flowchart of a task variable causal graph construction method according to an embodiment of the present application;

FIG. 3 is a schematic principle diagram of priori knowledge construction according to an embodiment of the present application;

FIG. 4 is a schematic flowchart of a Monte Carlo tree search method according to another embodiment of the present application;

FIG. 5 is a schematic diagram of functional modules in a task variable causal graph construction apparatus according to an embodiment of the present application; and

FIG. 6 is a schematic structural diagram of a computer device according to an embodiment of the present application.

### DETAILED DESCRIPTION OF THE EMBODIMENTS

The technical solutions in embodiments of the present application are described below clearly and completely with reference to the drawings in the embodiments of the present application. Apparently, the described embodiments are merely part rather than all of the embodiments of the present application. All other embodiments obtained by those of ordinary skill in the art based on the embodiments of the present application without creative efforts should fall within the protection scope of the present application.

To make the above objectives, features, and advantages of the present application more obvious and easy to understand, the present application will be further described in detail with reference to the accompanying drawings and specific implementations.

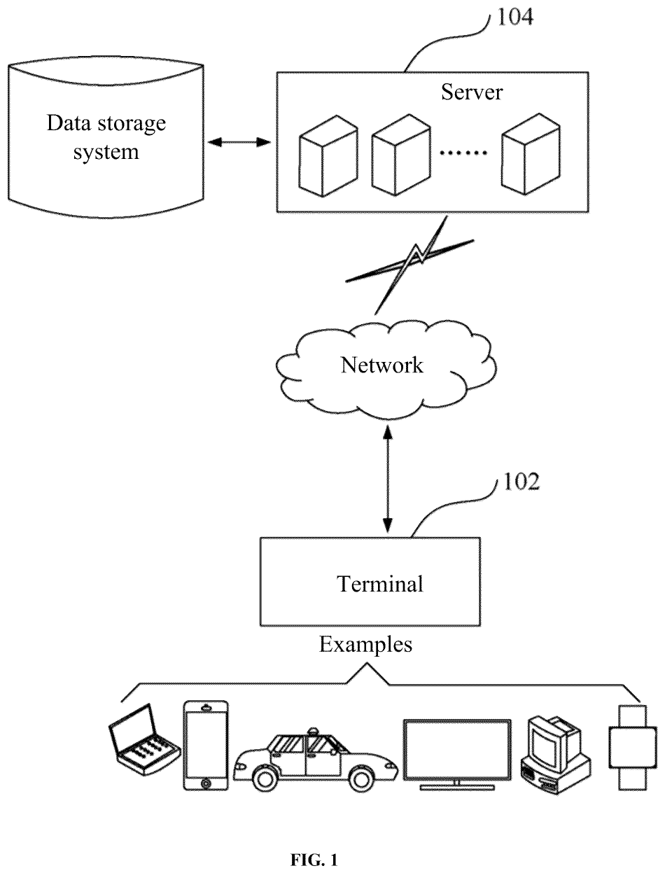

A task variable causal graph construction method provided in an embodiment of the present application can be applied to an application environment as shown in FIG. 1. A terminal 102 communicates with a server 104 over the network. A data storage system can store data to be processed by the server 104. The data storage system may be set up separately, integrated on the server 104, or provided on the cloud or other servers. The terminal 102 can send a variable set and application task information corresponding to a target application task to the server 104. After the server 104 receives the variable set and the application task information corresponding to the target application task, the server 104 determines priori knowledge by using a large language model based on the variable set and the application task information corresponding to the target application task, and determines a best causal graph by using a Monte Carlo tree search method based on the priori knowledge and data independence tests. The server 104 can feed back to the terminal 102 the best causal graph obtained for the target application task. In addition, in some embodiments, the task variable causal graph construction method may alternatively be realized by the server 104 or the terminal 102 alone. For example, the terminal 102 may directly construct the causal graph based on the variable set and the application task information corresponding to the target application task, or the server 104 may obtain from the data storage system the variable set and the application task information corresponding to the target application task, and construct the causal graph based on the variable set and the application task information corresponding to the target application task.

The terminal 102 may be, but is not limited to, various desktop computers, laptops, smartphones, and tablets. The server 104 may be implemented by a standalone server or a server cluster consisting of a plurality of servers, or may be a cloud server.

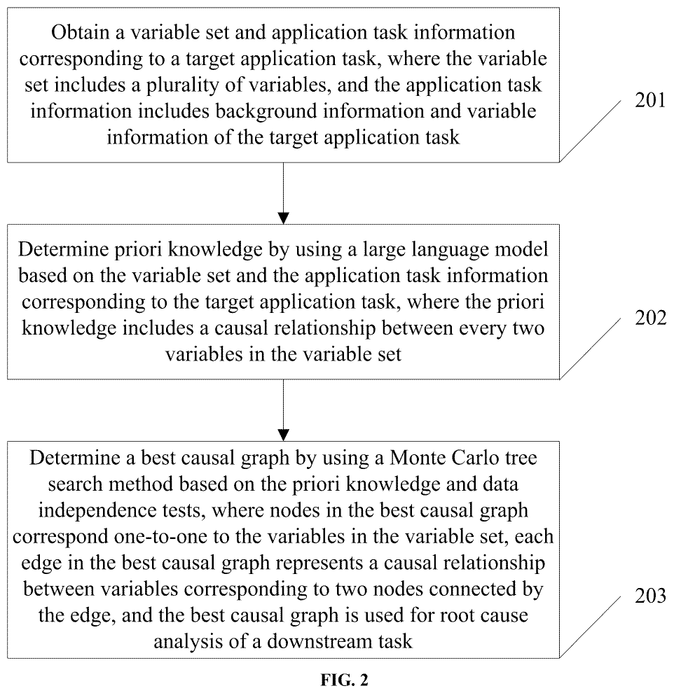

In an exemplary embodiment, as shown in FIG. 2, a task variable causal graph construction method is provided. The method is executed by a computer device, specifically, separately executed by a computer device such as the terminal or the server, or jointly executed by the terminal and the server. In this embodiment of the present application, the method applied to the server 104 in FIG. 1 is used as an example for description. The method includes the following steps 201 to 203. Specifically:

Step 201: Obtain a variable set and application task information corresponding to a target application task, where the variable set includes a plurality of variables, and the application task information includes background information and variable information of the target application task.

Step 202: Determine priori knowledge by using a large language model based on the variable set and the application task information corresponding to the target application task, where the priori knowledge includes a causal relationship between every two variables in the variable set.

Step 203: Determine a best causal graph by using a Monte Carlo tree search method based on the priori knowledge and data independence tests, where nodes in the best causal graph correspond one-to-one to the variables in the variable set, each edge in the best causal graph represents a causal relationship between variables corresponding to two nodes connected by the edge, and the best causal graph is used for root cause analysis of a downstream task.

The above steps 201 to 203 are implemented to infer the causal relationship between variables based on some given variables and observed variable data, to construct the causal graph. The causal graph is constructed through Monte Carlo tree searching, with pruning and optimization performed using the knowledge of the large language model based on the graph structure and data independence tests on variables. This approach speeds up the search process. Data analysis is used to feed back search results, enhancing the quality of the causal graph, which in turn improves the effectiveness of the downstream task. This method addresses the issue of existing causal discovery methods that rely heavily on data, which often results in low accuracy of causal graphs and poor performance of downstream tasks.

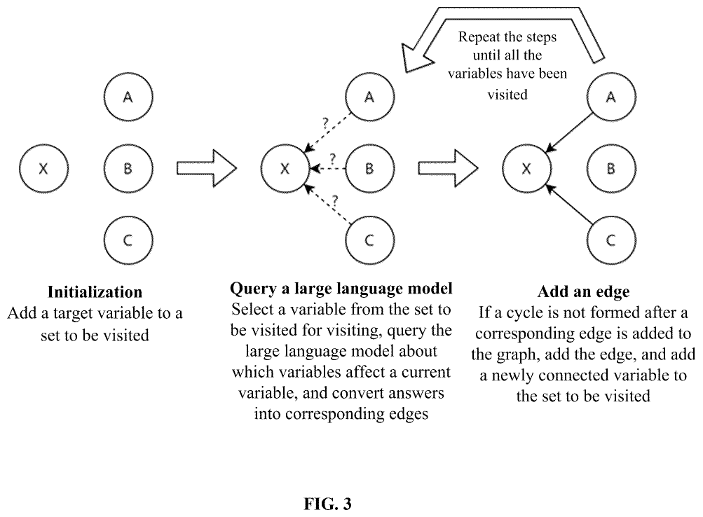

In another exemplary embodiment of the present application, as shown in FIG. 3, the above step 202 is replaced by the following steps 301 to 304.

Step 301: Analyze a current variable by using the large language model based on the variable set and the application task information corresponding to the target application task, to obtain an answer variable set corresponding to the current variable, where the current variable is any variable in the variable set, and an answer variable in the answer variable set is a variable, in the variable set, that affects the current variable.

Step 302: Construct an edge set corresponding to the current variable based on the answer variable set corresponding to the current variable.

Step 303: Determine whether each edge in the edge set satisfies a directed acyclic graph constraint; and if yes, adding the edge satisfying the directed acyclic graph constraint to a causal graph; or if no, deleting the edge that does not satisfy the directed acyclic graph constraint.

Step 304: Repeat the steps 301 to 303 until all variables in the variable set corresponding to the target application task are visited, to obtain the priori knowledge.

The large language model may be the ChatGPT model, the Qwen model, or the ERNIE Bot model.

Specifically, given n variables, the causal graph representing the causal relationship between the variables is constructed by using the large language model, and the causal graph needs to conform to the directed acyclic graph constraint. A specific process for priori knowledge construction is as follows:

It is assumed that N represents a set of all variables, V represents a set of nodes (variables) already in the causal graph, E represents a set of edges in the causal graph, and the causal graph G=(V, E). Steps are as follows:
1) An initial variable is selected from N and added into V, and generally a target variable concerned by the downstream task is selected.
2) A variable x having not been visited is selected from V. If all the variables in V have been visited, but N−V≠Ø, a variable x is selected from N−V.
3) Background knowledge, variable information, currently known causal relationships, and other information are provided to the large language model, such that the large language model can determine which variables directly affect the current variable x. According to answer variables Y={y1, y2, . . . } from the large language model, edges Enew={y1−>x, y2−>x, . . . } are obtained.
4) Whether each edge in Enew violates the directed acyclic graph constraint after being added into the causal graph G is determined; and if yes, the corresponding edge is deleted from Enew. The directed acyclic graph constraint requires the causal graph to conform to the definition of the directed acyclic graph, that is, there are no cycles in the causal graph.
5) The edges in Enew are added into the causal graph G, and corresponding variables and edges are added into V and E.
6) The steps 2) to 5) are repeated until all the variables have been visited, and the final causal graph G is obtained, that is, the priori knowledge is obtained.

A target variable is added to a set to be visited, and a variable is selected from the set to be visited for visiting. The large language model is queried about which variables affect the current variable, and answers from the large language model are converted into corresponding edges of the current variable. If a cycle is not formed after an edge corresponding to the current variable is added to the causal graph, the edge corresponding to the current variable is added to the causal graph, and a newly connected variable is added to the set to be visited.

The background knowledge refers to background knowledge related to an application task of a microservice architecture. For example, background knowledge of a microservice system includes known information of the system architecture and common sense and research results known in the field.

The variable information refers to additional descriptions of the variable, as the large language model may not understand the variable with the name alone.

The known causal relationships refer to previously obtained edges. Since the method is executed in a loop, the causal information (the edges in the graph) obtained from previous steps needs to be sent to the large language model.

The following target application task is used to illustrate the above contents. The application task information is as follows:

Background knowledge: Flow cytometry and mass spectrometry are used to measure expression levels of various proteins and phospholipids in human cells. This includes simultaneous measurement of 11 phosphorylated proteins and phospholipids from thousands of individual primary immune system cells, with both general and specific molecular interventions to understand the biological functions of the related proteins and phospholipids. Akt, a key signaling protein involved in cell survival and metabolic pathways, is among these. The goal of the task is to identify relevant variables that affect Akt activation and the causal relationships therebetween.

Variable set: 11 variables are included, such as Plcg, PIP2, PIP3, PKC, PKA, Raf, Mek, Erk, Akt, Jnk, and P38.

Variable information: Variable information of the above 11 phosphorylated proteins and phospholipids is described as follows:

Plcg (Phospholipase C gamma) is an enzyme involved in signal transduction that catalyzes the production of a second messenger.

PIP2 (Phosphatidylinositol 4,5-bisphosphate) is a membrane phospholipid involved in signal transduction pathways.

PIP3 (Phosphatidylinositol (3,4,5)-trisphosphate) is a phospholipid derived from PIP2, involved in cell growth and survival signaling.

PKC (Protein Kinase C) is a protein kinase that regulates various cellular functions.

PKA (Protein Kinase A) is a protein kinase that regulates sugar metabolism and the cell cycle.

Raf is a protein kinase in tandem within the mitogen-activated protein kinase (MAPK) signaling pathway and involved in cell proliferation.

Mek is a kinase in the MAPK signaling pathway that activates Erk.

Erk (Extracellular Signal-Regulated Kinase) is a protein kinase involved in cell division and growth.

Akt, also known as PKB, is a protein kinase that regulates cell survival and metabolism.

Jnk (c-Jun N-terminal Kinase) is a protein kinase involved in stress response and apoptosis.

P38 is a MAPK protein kinase involved in the cellular stress response.

It should be noted that the best causal graph can be used for downstream tasks. After determining the best causal graph and a predictive model, the model is fitted with data. The completed model can perform various tasks. In the above task scenario, the goal is to build the best causal graph among the 11 variables. The downstream task involves using the best causal graph to identify the cause of an abnormal event. For example, if abnormal Akt activation is detected in a patient, the causal graph can help determine which variables are responsible for the improper Akt activation.

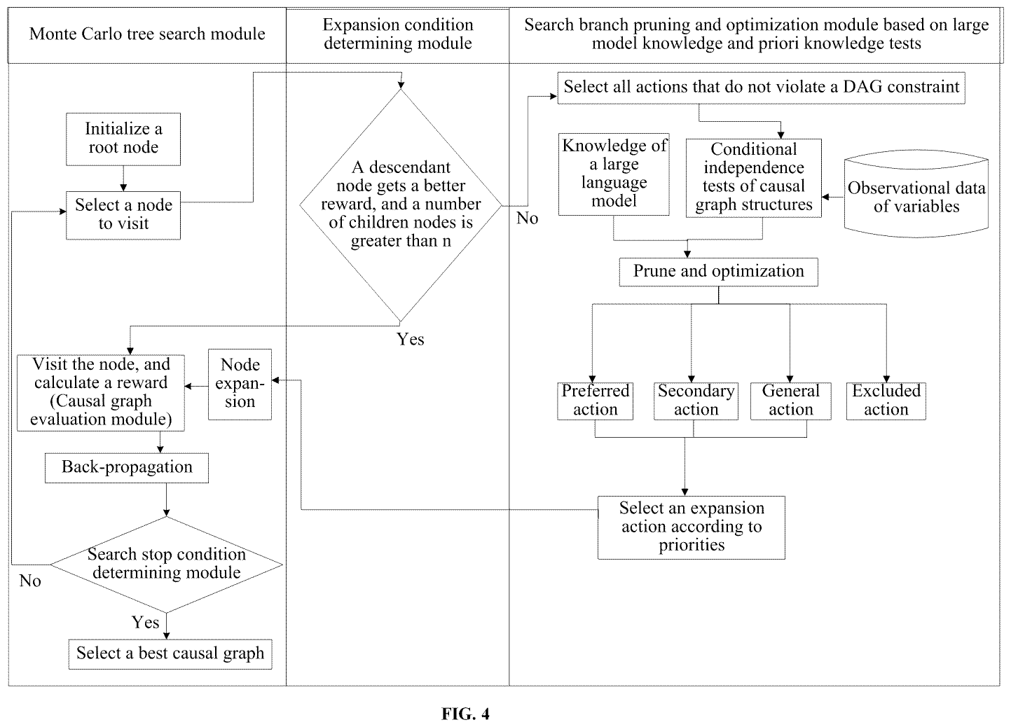

In another exemplary embodiment of the present application, as shown in FIG. 4, a causal graph construction framework is provided, including a search branch pruning and optimization module based on large model knowledge and causal graph structure tests, a node expansion condition determining module, and a Monte Carlo tree search module.

The above step 203 may include the following steps 401 to 408: Specifically:

Step 401: Initialize a root node.

Step 402: Select, based on the root node, a node to visit.

Step 403: Determine whether the node to visit needs to be expanded; and if yes, go to a step 404; or if no, go to a step 406.

Step 404: Prune and optimize all expansion actions corresponding to the current node based on the priori knowledge and data independence tests, to obtain candidate actions.

Step 405: Select an expansion action according to action priorities of the candidate actions, to create a new node for the current node, take the new node as a node to visit, and go to the step 406.

Step 406: Calculate a causal graph reward of the node to visit, and evaluate, based on the causal graph reward, a causal graph corresponding to the node to visit, to obtain an evaluation score.

Step 407: Back-propagate the causal graph reward of the node to visit.

Step 408: Determine whether a search stop condition is satisfied; and if yes, stop searching and output the best causal graph; or if no, return to the step 402.

Said initializing the root node includes: An empty graph (or a causal graph known through other methods or from expert knowledge) is used as the root node (an initial state). Specifically, if searching is expected to be performed based on the existing causal graph Gᵢₙᵢₜ (such as a causal graph constructed from expert knowledge), the existing causal graph is used to initialize the root node. Otherwise, an empty graph Gᵢₙᵢₜ=G_{empty}={V, E=Ø} is used to initialize the root node. A node (state) in the Monte Carlo tree search method represents a causal graph. The root node may be the empty causal graph, or the causal graph known through other (traditional) methods or from expert knowledge, that is, the initial causal graph formed based on the priori knowledge obtained in the step 202. A node (state) is defined as follows:

nodeᵢ=stateᵢ={Gᵢ, parentᵢ, mumVisitsᵢ, childrenᵢ, Rewardᵢ, patienceᵢ, totalRewardᵢ, bestDescRewardᵢ}. Gi is the causal graph corresponding to the current node i, parentᵢ is the parent node, mumVisitsᵢ is the number of node visits of the current node i, childrenᵢ is the number of children nodes, Rewardᵢ is the causal graph reward of the current node i, patienceᵢ is the count of visits to the node without improvement in the causal graph reward, totalRewardᵢ is the sum of causal graph rewards from each visit to the descendant nodes (including the current node), and bestDescRewardᵢ is the highest causal graph reward among the descendant nodes (including the current node).

Therefore, the root node after initialization is nodeᵢₙᵢₜ=Stateᵢₙᵢₜ={Gᵢₙᵢₜ, parent=Ø, numVisits=0, children=Ø, reward=0, patience=0, totalReward=0, bestDescReward=0}.

The specific process for selecting a node to visit in the step 402 includes: selecting the node to visit based on the root node initialized in the step 401; calculating an Upper Confidence bounds applied to Trees (UCT) value of each node, and selecting a node with the highest UCT value as the node to visit.

The UCT value reflects the priority of nodes during search, balancing exploration and exploitation. The formula for calculating the UCT value is as follows:

$${UCT}_{i} = a \times {BestChildReward}_{i} + b \times {X}_{i} + c \times \sqrt{\frac{2 ln {N}_{C}}{{N}_{i}}} .$$

BestChildRewardᵢ is the highest causal graph reward among the descendant nodes (including the current node), highlighting the priority of searching the current best nodes.

$${X}_{i} = \frac{{totalReward}_{i}}{{numVisits}_{i}}$$

is the average causal graph reward from visits to the current node and descendant nodes, highlighting the priority of searching the node with the best average causal graph reward among the descendants. N_{C} is the total number of visits to the parent node, Nᵢ is the number of visits to the current node, and

$$\sqrt{\frac{2 ln {N}_{C}}{{N}_{i}}}$$

highlighting the priority of searching a node that has been visited less frequently. a, b, and c are constant parameters used to adjust the relative importance of each component in the priority calculation, and can be set as required. In the present application, the values are set as a=0.9, b=0.1 and c=0.05.

The node expansion condition determining module is configured to: determine whether the node selected in the step 402 needs to be expanded; and if yes, go to step the 404; or if no, directly visit the node selected in the step 402 and go to the step 406.

Said determining whether the node to visit selected in the step 402 needs to be expanded specifically includes: if a causal graph reward of a descendant node is greater than that of the current node (that is, bestDescReward>reward), and the number of children nodes of the current node exceeds a set threshold (|children|>Num), directly visiting the node selected in the step 402 and going to the step 406; otherwise, continuing to perform the step 404. Num may be 5.

The search branch pruning and optimization module based on large model knowledge and causal graph structures is configured to: prune and optimize all possible expansion actions of the current node. The obtained candidate actions are used to expand the node in the step 405. A specific process is as follows:
1) First, all possible actions are traversed and an action is selected as the candidate action if the changed causal graph does not violate the directed acyclic graph constraint. For the edge X->Y corresponding to each action, a conditional variable set (a node set) that can block the path between X and Y, excluding the directly connected edge, is identified according to the d-separation rule in the causal graph. The conditional variable set is used as a condition to perform independence tests of X and Y with the observed data, to obtain the p-value.
2) Then, the candidate actions are pruned and optimized based on the p-value from the conditional independence tests and the results (priori knowledge) from the causal discovery of the large language model. The process can be divided into four scenarios: (1) Direct exclusion: If the p-value is very low (less than 0.01) or low (less than 0.25) with no corresponding causal relationship in the results of the large language model, the action is excluded directly. (2) Preferred action: If the p-value is higher (greater than 0.05) and there is a corresponding causal relationship in the results of the large language model, the action is selected with the highest priority and added into a preferred action set. (3) Secondary action: If the p-value is higher (greater than 0.05) or there is a corresponding causal relationship in the results of the large language model, the action is selected with the secondary priority and added into a secondary action set. (4) General action: The remaining actions are added into a general action set. The threshold for the p-value can be adjusted as needed.

The action (changing from one state to another) in the Monte Carlo tree search method refers to modification of the edge in the causal graph, including adding, deleting and reversing. An action is defined as: action={ops, vari, varj}. ops refers to one of the three operations: adding, deleting, or reversing. vari and varj are two variables corresponding to the edge to be modified.

Node expansion includes selecting actions from the candidate actions in the step 404, in priority order, to create new children nodes for the current node. The created new node is used as the node to visit in the step 406.

All actions that do not violate the directed acyclic graph constraint are selected. The causal graph of the node selected in the step 402 is used as the current causal graph. All possible operations of adding, deleting and reversing the edges of the current causal graph are traversed and used as possible actions. Whether the causal graph includes a cycle after the actions are performed is tested; and if no, the directed acyclic graph constraint is not violated. Actions that do not violate the directed acyclic graph constraint are used as the candidate actions in the step 404.

The children nodes of the node selected in the step 402 is expanded based on the set of candidate actions selected in the step 404. An action is selected in the priority order of the preferred action set, the secondary action set, and the general action set. Edge modification of the selected action is performed on the causal graph G_{old} of the node selected in the step 402, to obtain a new causal graph G_{new}. A new node is created with G_{new} and is used as a sub-byte of the node selected in the step 402. The newly created node is used as the node to visit, and the step 408 is executed.

The node is visited and the causal graph reward is calculated. If it is determined in the step 403 that node expansion is not needed, the node selected in the step 402 is visited; or if it is determined in the step 404 that node expansion is needed, the new node expanded in the following step is visited. A causal graph evaluation module is used to calculate the causal graph reward of the node to visit. The causal graph reward uses observational data to evaluate the quality of the causal graph and utilizes data to feed back the search quality. A calculation formula of the causal graph reward is as follows:

$$Rewardi = Evaluate ( {G}_{i} ) - a \times NHD ( {G}_{i} , {G}_{empty} ) .$$

Gᵢ denotes the causal graph of the node. Evaluate is the evaluation function for the causal graph. NHD (Gᵢ, G_{empty}) denotes the normalized Hamming distance between the causal graph and the empty graph. a is a parameter that can be set as needed, with a suggested value of 0.2. NHD (Gᵢ, G_{empty}) denotes the normalized Hamming distance between the causal graph and the empty graph. That is, the number of edges existing in Gi is divided by the number of all possible edges.

Evaluate is the evaluation function for the causal graph, and there are various options available. The causal graph may be evaluated based on the effect on the downstream task. In the present application, the F1-reward for the root cause analysis task is selected as the evaluation function. The root cause analysis method for abnormal value based on the causal structure is used to determine the contribution of each variable to the abnormality of the target variable. The variable with the highest abnormal reward is identified as the predicted root cause. The predicted root cause is then compared with a true label of the abnormality root cause of the abnormal data set, to calculate the F1-reward for root cause analysis. A specific calculation process is as follows:

Variables X1, X2, . . . , and Xn are assumed, including a concerned target variable Xtarget, a normal data set, that is, a set of observation samples of variables under normal conditions, and an abnormal data set, that is, a set of abnormal data observation samples of variables and root cause labels. The root cause analysis method is used to calculate the contribution of each variable in each abnormal data set to the abnormality of the target variable Xtarget, that is, the abnormality rewards: AX1, AX2, . . . , and AXn. The highest reward max (AXi) is selected, and Xi is the predicted root cause. If Xi is the same as the root cause label, the prediction is correct. Finally, for all prediction results, the predicted F1-reward is calculated using the Macro F1 reward for multi-class classification. For each variable Xi:

$${precision}_{i} = \frac{{TP}_{i}}{{TP}_{i} + {FP}_{i}}$$

$${recall}_{i} = \frac{{TP}_{i}}{{TP}_{i} + {FN}_{i}} ; and$$

$${F}_{1} ( i ) = 2 \times \frac{{precision}_{i} \times {recall}_{i}}{{precision}_{i} + {recall}_{i}} .$$

The final F1-reward is as follows: Macro F1=AVG (F1 (1), F1 (2), . . . , F1 (n)).

The calculation formula of NHD (Gᵢ, G_{empty}) is as follows:

$$NHD ( {G}_{i} , {G}_{empty} ) = \frac{1}{{N}_{nodes} \times ( {N}_{nodes} - 1 )} \times {\sum }_{e}^{E} \{ \begin{matrix}0 & if e ∈ {G}_{i} ⋀ e ∈ {G}_{empty} \\ 0 & if e ∉ {G}_{i} ⋀ e ∉ {G}_{empty} \\ 1 & others\end{matrix} .$$

N_{nodes} is the number of variables, e is the edge, and E is the set of all edges.

The specific process of the step 407 involving visiting the node, calculating the causal graph reward, and then back-propagating the causal graph reward to all ancestor nodes (including the current node). The number of visits to the ancestor node node_{ance} increases by 1 (mumVisits_{ance}+=1), and the causal graph reward of the node visited is added to totalReward (totalRewardance+=Rewardi). If reward of the node visited is greater than the causal graph reward of the ancestor node (Rewardi>Reward_{ance}), bestDescReward_{ance}=rewardᵢ and patience_{ance}=0; otherwise, patience is increased by 1 (patience_{ance}+=1).

The search stop condition determining module is configured to: set an upper limit of search times and search time, and stop when the upper limit is reached. In addition, an early stop condition is set. When the causal graph reward is not improved for n consecutive searches, searching is stopped earlier. Whether to stop searching is determined; and if no, the steps 402 to 407 are repeated for searching.

The best causal graph is selected. After the search is stopped, all the causal graphs found during the search process are sorted according to Reward, and the causal graph with the highest causal graph reward is selected as the result output. Alternatively, top causal graphs with higher rewards are used as candidate causal graphs for user reference and selection.

The present application further provides an application scenario to which the above task variable causal graph construction method is applied. Specifically, the task variable causal graph construction method provided in the embodiments can be applied to the causal graph construction scenario. The causal graph construction scenario includes an information collection phase and a causal graph construction phase. The variable set and the application task information corresponding to the target application task enter the causal graph construction phase from the information collection phase, to obtain the corresponding best causal graph. The task variable causal graph construction method provided in the embodiments belongs to the causal graph construction phase. Specifically, in the process of the causal graph construction phase for the variable set and the application task information corresponding to the target application task, the large language model may be used to determine the priori knowledge based on the variable set and the application task information corresponding to the target application task, and the Monte Carlo tree search method is used to determine the best causal graph based on the priori knowledge and data independence tests.

Based on the same inventive concept, an embodiment of the present application further provides a task variable causal graph construction apparatus for realizing the above task variable causal graph construction method. The solution provided by the apparatus is similar to that described in the above method. For specific limitations on the embodiment of the task variable causal graph construction apparatus, reference may be made to the limitations on the above task variable causal graph construction method. Details are not described herein again.

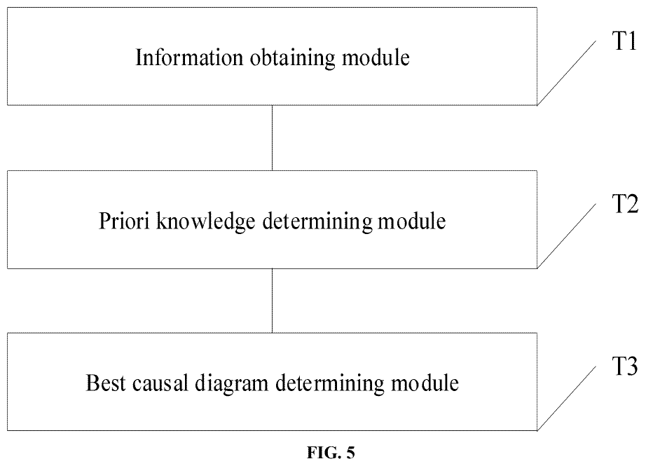

In an exemplary embodiment, as shown in FIG. 5, a task variable causal graph construction apparatus is provided, including:

An information obtaining module T1 is configured to obtain a variable set and application task information corresponding to a target application task, where the variable set includes a plurality of variables, and the application task information includes background information and variable information of the target application task.

A priori knowledge determining module T2 is configured to determine priori knowledge by using a large language model based on the variable set and the application task information corresponding to the target application task, where the priori knowledge includes a causal relationship between every two variables in the variable set.

A best causal graph determining module T3 is configured to determine a best causal graph by using a Monte Carlo tree search method based on the priori knowledge and data independence tests, where nodes in the best causal graph correspond one-to-one to the variables in the variable set, each edge in the best causal graph represents a causal relationship between variables corresponding to two nodes connected by the edge, and the best causal graph is used for root cause analysis of a downstream task.

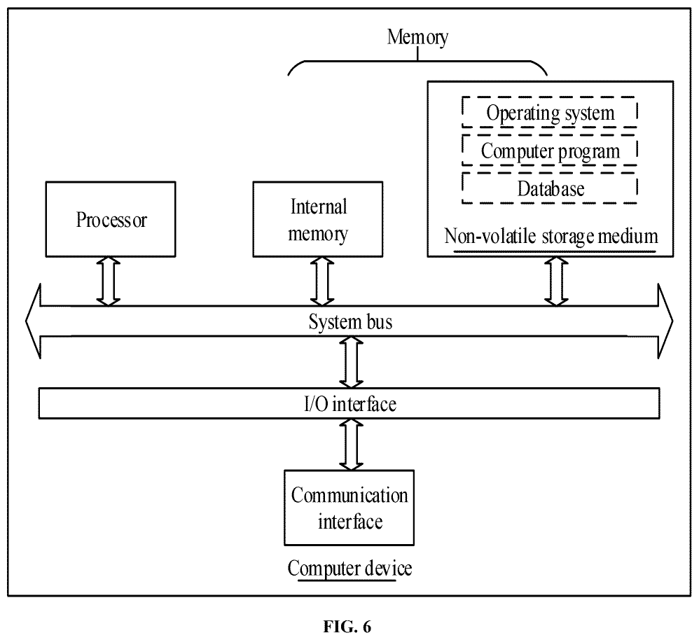

In an exemplary embodiment, a computer device is provided. The computer device may be a server or a terminal, and an internal structure thereof may be as shown in FIG. 6. The computer device includes a processor, a memory, an input/output (I/O) interface, and a communication interface. The processor, the memory and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for operations of the operating system and the computer program in the non-volatile storage medium. The database of the computer device is configured to store data for causal graph construction. The input/output interface of the computer device is configured to exchange information between the processor and an external device. The communication interface of the computer device is configured to communicate with an external terminal through a network. When the computer program is executed by the processor, a task variable causal graph construction method is implemented.

Those skilled in the art may understand that the structure shown in FIG. 6 is only a block diagram of a part of the structure related to the solutions of the present application and does not constitute a limitation on a computer device to which the solutions of the present application are applied. Specifically, the computer device may include more or less components than those shown in the figure, or combine some components, or have different component arrangements.

In an exemplary embodiment, a computer device is further provided, including a memory and a processor. The memory stores a computer program, and the computer program is executed by the processor to implement the steps of the above method embodiment.

In an exemplary embodiment, a computer-readable storage medium is provided. The computer-readable storage medium stores a computer program, and the computer program is executed by a processor to implement the steps of the above method embodiment.

It is to be noted that user information (including but not limited to device information and personal information of the user) and data (including but not limited to data for analysis, data for storage, and data for exhibition) in the present application are information and data authorized by the user or fully authorized by each party, and relevant data shall be acquired, used and processed according to laws, regulations and standards of related countries and regions.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The non-volatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present application may include at least one of a relational database and a non-relational database. The non-relational database may include a distributed database based on a blockchain, but is not limited thereto. The processor in the embodiments of the present application may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A task variable causal graph construction method, comprising:
obtaining a variable set and application task information corresponding to a target application task, wherein the variable set comprises a plurality of variables, and the application task information comprises background information and variable information of the target application task;
determining priori knowledge by using a large language model based on the variable set and the application task information corresponding to the target application task, wherein the priori knowledge comprises a causal relationship between every two variables in the variable set; and
determining a best causal graph by using a Monte Carlo tree search method based on the priori knowledge and data independence tests, wherein nodes in the best causal graph correspond one-to-one to the variables in the variable set, each edge in the best causal graph represents a causal relationship between variables corresponding to two nodes connected by the edge, and the best causal graph is used for root cause analysis of a downstream task.

2. The task variable causal graph construction method according to claim 1, wherein said determining priori knowledge by using a large language model based on the variable set and the application task information corresponding to the target application task specifically comprises:
step 301: analyzing a current variable by using the large language model based on the variable set and the application task information corresponding to the target application task, to obtain an answer variable set corresponding to the current variable, wherein the current variable is any variable in the variable set, and an answer variable in the answer variable set is a variable, in the variable set, that affects the current variable;
step 302: constructing an edge set corresponding to the current variable based on the answer variable set corresponding to the current variable;
step 303: determining whether each edge in the edge set satisfies a directed acyclic graph constraint; and if yes, adding the edge satisfying the directed acyclic graph constraint to a causal graph; or if no, deleting the edge that does not satisfy the directed acyclic graph constraint; and
step 304: repeating the steps 301 to 303 until all variables in the variable set corresponding to the target application task are visited, to obtain the priori knowledge.

3. The task variable causal graph construction method according to claim 1, wherein said determining a best causal graph by using a Monte Carlo tree search method based on the priori knowledge and data independence tests specifically comprises:
step 401: initializing a root node;
step 402: selecting, based on the root node, a node to visit;
step 403: determining whether the node to visit needs to be expanded; and if yes, going to a step 404; or if no, going to a step 406;
step 404: pruning and optimizing all expansion actions corresponding to the current node based on the priori knowledge and data independence tests, to obtain candidate actions;
step 405: selecting an expansion action according to action priorities of the candidate actions, to create a new node for the current node, taking the new node as a node to visit, and going to the step 406;
step 406: calculating a causal graph reward of the node to visit, and evaluating, based on the causal graph reward, a causal graph corresponding to the node to visit, to obtain an evaluation score;
step 407: back-propagating the causal graph reward of the node to visit; and
step 408: determining whether a search stop condition is satisfied; and if yes, stopping searching and outputting the best causal graph; or if no, returning to the step 402.

4. A task variable causal graph construction apparatus, comprising:
an information obtaining module configured to obtain a variable set and application task information corresponding to a target application task, wherein the variable set comprises a plurality of variables, and the application task information comprises background information and variable information of the target application task;
a priori knowledge determining module configured to determine priori knowledge by using a large language model based on the variable set and the application task information corresponding to the target application task, wherein the priori knowledge comprises a causal relationship between every two variables in the variable set; and
a best causal graph determining module configured to determine a best causal graph by using a Monte Carlo tree search method based on the priori knowledge and data independence tests, wherein nodes in the best causal graph correspond one-to-one to the variables in the variable set, each edge in the best causal graph represents a causal relationship between variables corresponding to two nodes connected by the edge, and the best causal graph is used for root cause analysis of a downstream task.

5. A computer device, comprising: a memory, a processor, and a computer program stored in the memory and executable on the processor, wherein the processor executes the computer program to implement the task variable causal graph construction method according to claim 1.

6. A non-transitory computer-readable storage medium, storing a computer program thereon, wherein the computer program, when executed by a processor, implements the task variable causal graph construction method according to claim 1.

7. The computer device according to claim 5, wherein said determining priori knowledge by using a large language model based on the variable set and the application task information corresponding to the target application task specifically comprises:
step 301: analyzing a current variable by using the large language model based on the variable set and the application task information corresponding to the target application task, to obtain an answer variable set corresponding to the current variable, wherein the current variable is any variable in the variable set, and an answer variable in the answer variable set is a variable, in the variable set, that affects the current variable;
step 302: constructing an edge set corresponding to the current variable based on the answer variable set corresponding to the current variable;
step 303: determining whether each edge in the edge set satisfies a directed acyclic graph constraint; and if yes, adding the edge satisfying the directed acyclic graph constraint to a causal graph; or if no, deleting the edge that does not satisfy the directed acyclic graph constraint; and
step 304: repeating the steps 301 to 303 until all variables in the variable set corresponding to the target application task are visited, to obtain the priori knowledge.

8. The computer device according to claim 5, wherein said determining a best causal graph by using a Monte Carlo tree search method based on the priori knowledge and data independence tests specifically comprises:
step 401: initializing a root node;
step 402: selecting, based on the root node, a node to visit;
step 403: determining whether the node to visit needs to be expanded; and if yes, going to a step 404; or if no, going to a step 406;
step 404: pruning and optimizing all expansion actions corresponding to the current node based on the priori knowledge and data independence tests, to obtain candidate actions;
step 405: selecting an expansion action according to action priorities of the candidate actions, to create a new node for the current node, taking the new node as a node to visit, and going to the step 406;
step 406: calculating a causal graph reward of the node to visit, and evaluating, based on the causal graph reward, a causal graph corresponding to the node to visit, to obtain an evaluation score;
step 407: back-propagating the causal graph reward of the node to visit; and
step 408: determining whether a search stop condition is satisfied; and if yes, stopping searching and outputting the best causal graph; or if no, returning to the step 402.

9. The non-transitory computer-readable storage medium according to claim 6, wherein said determining priori knowledge by using a large language model based on the variable set and the application task information corresponding to the target application task specifically comprises:
step 301: analyzing a current variable by using the large language model based on the variable set and the application task information corresponding to the target application task, to obtain an answer variable set corresponding to the current variable, wherein the current variable is any variable in the variable set, and an answer variable in the answer variable set is a variable, in the variable set, that affects the current variable;
step 302: constructing an edge set corresponding to the current variable based on the answer variable set corresponding to the current variable;
step 303: determining whether each edge in the edge set satisfies a directed acyclic graph constraint; and if yes, adding the edge satisfying the directed acyclic graph constraint to a causal graph; or if no, deleting the edge that does not satisfy the directed acyclic graph constraint; and
step 304: repeating the steps 301 to 303 until all variables in the variable set corresponding to the target application task are visited, to obtain the priori knowledge.

10. The non-transitory computer-readable storage medium according to claim 6, wherein said determining a best causal graph by using a Monte Carlo tree search method based on the priori knowledge and data independence tests specifically comprises:
step 401: initializing a root node;
step 402: selecting, based on the root node, a node to visit;
step 403: determining whether the node to visit needs to be expanded; and if yes, going to a step 404; or if no, going to a step 406;
step 404: pruning and optimizing all expansion actions corresponding to the current node based on the priori knowledge and data independence tests, to obtain candidate actions;
step 405: selecting an expansion action according to action priorities of the candidate actions, to create a new node for the current node, taking the new node as a node to visit, and going to the step 406;
step 406: calculating a causal graph reward of the node to visit, and evaluating, based on the causal graph reward, a causal graph corresponding to the node to visit, to obtain an evaluation score;
step 407: back-propagating the causal graph reward of the node to visit; and
step 408: determining whether a search stop condition is satisfied; and if yes, stopping searching and outputting the best causal graph; or if no, returning to the step 402.
